(19) United States
(12) Patent Application Publication
(10) Pub. No.: US 2009/0179489 A1
(43) Pub. Date: Jul. 16, 2009

(54) HIGH-EFFICIENCY POWER SUPPLY DEVICE

(76) Inventor: Ming-Ho HUANG, Taipei Hsien (TW)

Correspondence Address: SINORICA, LLC, 2275 Research Blvd., Suite 500, ROCKVILLE, MD, 20850, US

(21) Appl. No.: 12/198,211

(22) Filed: Aug. 26, 2008

(30) Foreign Application Priority Data
Jan. 15, 2008 (TW) 097200892

(51) Int. Cl. H02J 1/00

(52) U.S. Cl. 307/31

(57) ABSTRACT

A high-efficiency power supply device includes a main voltage output unit, which has at least one first DC voltage output and a second DC voltage output, a backup voltage output unit, which has at least one DC voltage output, and a switch. When the main voltage output unit is turned on, the switch is switched on, and the main voltage output unit outputs the first DC voltage. When the main voltage output unit is turned off, the switch is off, and the backup voltage output unit the DC voltage to the first DC voltage output of the main voltage output unit.

### BACKGROUND OF THE INVENTION

1. Field of the Invention

The present invention relates to a power supply device and more particularly, to a high-efficiency power supply device, which automatically regulates the voltage output efficiency by means of: having the relatively higher efficiency main voltage output unit output +5V when the main voltage output unit is turned on and having the relatively lower efficiency backup voltage output unit output +5V when the main voltage output unit is turned off.

2. Description of the Related Art

A conventional power supply device, for example, LLC resonant converter, as shown in FIG. 1, generally comprises a relatively higher efficiency main voltage output unit 100 and a relatively lower efficiency backup voltage output unit 200. The main voltage output unit 100 outputs +12V, +5V, +3.3V, and/or −12V. The backup voltage output unit 200 outputs +5V. When the main voltage output unit 100 is off, the backup voltage output unit 200 provides the necessary working voltage to an IC or remote control receiving circuit on a printed circuit board (not shown, for example, the motherboard of a computer.

According the aforesaid design of LLC resonant converter, the output of the main voltage output unit 100 and the output of the backup voltage output unit 200 are independent outputs, i.e., when the relatively higher efficiency main voltage output unit 100 is turned on, the relatively lower efficiency backup voltage output unit 200 still needs to provide electricity to the IC or remote control receiving circuit, lowering the power supply efficiency of the LLC resonant converter.

Therefore, it is desirable to provide a high-efficiency power supply device that eliminates the aforesaid drawback.

### SUMMARY OF THE INVENTION

The present invention has been accomplished under the circumstances in view. It is one object of the present invention to provide a high-efficiency power supply device, which automatically regulates the voltage output efficiency by means of: having the relatively higher efficiency main voltage output unit output +5V when the main voltage output unit is turned on and having the relatively lower efficiency backup voltage output unit output +5V when the main voltage output unit is turned off.

To achieve this and other objects of the present invention, the high-efficiency power supply device comprises a main voltage output unit, a backup voltage output unit and a switch. The main voltage output unit comprises at least one first DC voltage output and a second DC voltage output. The backup voltage output unit has an efficiency lower than the main voltage output unit. Further, the backup voltage output unit comprises at least one DC voltage output. The switch is a TRIAC, comprising a first terminal coupled to the at least one first DC voltage output of the main voltage output unit, a second terminal coupled to the main voltage output unit, and a third terminal coupled to the at least one DC voltage output of the backup voltage output unit. When the main voltage output unit is turned on, the switch is switched on, and the main voltage output unit outputs one first DC voltage. When the main voltage output unit is turned off, the switch is switched off, and the backup voltage output unit outputs one DC voltage to one one first DC voltage output of the main voltage output unit.

### BRIEF DESCRIPTION OF THE DRAWINGS

FIG. 1 is a block diagram of a power supply device according to the prior art.

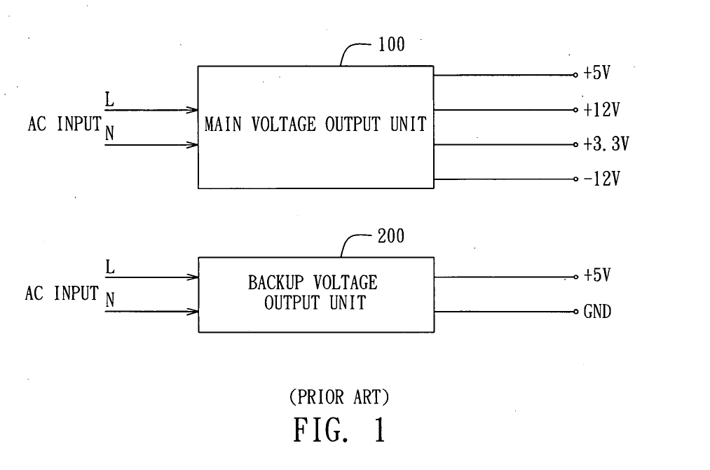

FIG. 2 is a block diagram of a power supply device according to the present invention.

### DETAILED DESCRIPTION OF THE PREFERRED EMBODIMENT

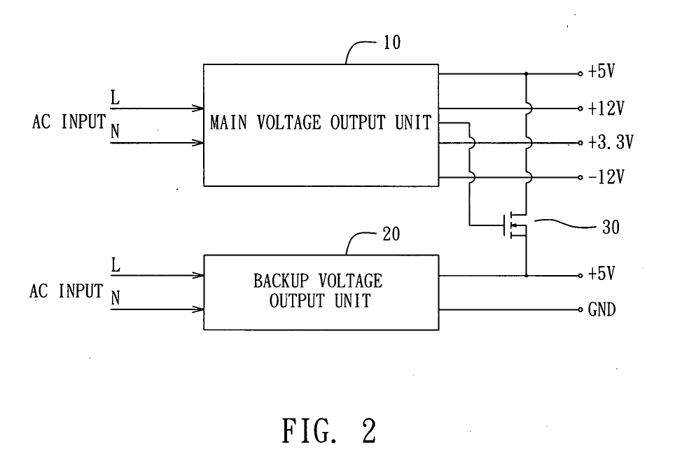

Referring to FIG. 2, a high-efficiency in accordance with the present invention is shown comprising a main voltage output unit 10, a backup voltage output unit 20, and a switch 30.

The main voltage output unit 10 has a relatively higher efficiency, for example, but not limited to 92%, and at least one first DC voltage output and a second DC voltage output. The main voltage output unit 10 can be, but not limited to, a LLC resonant converter, which is a regular known power supply device, and therefore no further detailed description in this regard is necessary. The main voltage output unit 10 can be designed to provide +12V, +5V, +3.3V and −12V voltage outputs. The first DC voltage can be +5V The second DC voltage can be +12V.

The backup voltage output unit 20 has a relatively lower efficiency, for example, but not limited to 70%, and at least one DC voltage output, for example, +5V Because the chance to use the backup voltage output unit 20 is low, the backup voltage output unit 20 is designed to have a relatively lower efficiency, thereby saving the cost of design and spare parts.

The switch 30 is a TRIAC, having a first terminal coupled to the first DC voltage output of the main voltage output unit 10, a second terminal coupled to the main voltage output unit 10, and a third terminal coupled to the DC voltage output of the backup voltage output unit 20. The switch 30 can be, but not limited to, a transistor or power switch. In case of transistor, the switch 30 can be a NPN or PNP transistor. In case of power switch, the switch 30 can be a N-pass metal oxide semiconductor field effect transistor, N-pass junction metal oxide semiconductor field effect transistor, P-pass metal oxide semiconductor field effect transistor, or P-pass junction metal oxide semiconductor field effect transistor.

In case the switch 30 is a transistor, the first terminal is the collector, the second terminal is the base, and the third terminal is the emitter.

In case the switch 30 is a power switch, the first terminal is the drain of the metal oxide field effect transistor, the second terminal is the gate of the metal oxide field effect transistor, and the third terminal is the source of the metal oxide field effect transistor. According to the present preferred embodiment, the switch 30 is a N-pass junction metal oxide semiconductor field effect transistor.

Further, the second terminal of the switch 30 can be coupled to the second DC voltage output of the main voltage output unit 10, for example, +12V or control signal C of the main voltage output unit 10.

During operation, when the main voltage output unit 10 is turned on, the main voltage output unit 10 outputs a high potential control signal C to conduct the switch 30. At this time, the first DC voltage (+5V) outputted by the main voltage output unit 10 is sent to the load (not shown). At the same time, the main voltage output unit 10 also outputs the first DC voltage (+5V) to the device been coupled to the backup voltage output unit 20 via the switch 30.

When the main voltage output unit 10 is off, the control signal C is at floating or low potential to switch off the switch 30. At this time, the main voltage output unit 10 stops all voltage outputs, and the backup voltage output unit 20 outputs +5V to the coupled device.

Thus, by means of switching on/off the switch 30, the main voltage output unit 10 or the backup voltage output unit 20 is controlled to output +5V to the coupled device or load. When the main voltage output unit 10 is off, the relatively lower efficiency backup voltage output unit 20 provides +5V power supply. Therefore, the invention improves the power output efficiency of the power supply device, reducing power waste.

By means of the application of the high-efficiency power supply device of the present invention, the main voltage output unit provides +5V DC power supply when it is turned on, and the backup voltage output unit outputs +5V power supply when the main voltage output unit is off, achieving regulation of output efficiency and eliminating the drawbacks of the prior art power supply device design.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A high-efficiency power supply device, comprising:
a main voltage output unit, said main voltage output unit comprising at least one first DC voltage output and a second DC voltage output;
a backup voltage output unit, said backup voltage output unit having an efficiency lower than said main voltage output unit, said backup voltage output unit comprising at least one DC voltage output; and
a switch formed of a TRIAC, said switch comprising a first terminal coupled to said at least one first DC voltage output of said main voltage output unit, a second terminal coupled to said main voltage output unit, and a third terminal coupled to the at least one DC voltage output of said backup voltage output unit;
wherein when said main voltage output unit is turned on, said switch is switched on, and said main voltage output unit outputs one said first DC voltage; when said main voltage output unit is turned off, said switch is switched off, and said backup voltage output unit outputs one DC voltage to one said first DC voltage output of said main voltage output unit.

2. The high-efficiency power supply device as claimed in claim 1, wherein said main voltage output unit is a LLC power converter.

3. The high-efficiency power supply device as claimed in claim 2, wherein said LLC power converter has an efficiency about 92%.

4. The high-efficiency power supply device as claimed in claim 2, wherein said LLC power converter is controllable to output +12V, +5V, +3.3V and −12V DC voltages; said at least one first DC voltage comprises +5V; said second DC voltage is +12V.

5. The high-efficiency power supply device as claimed in claim 1, wherein said backup voltage output unit outputs +5V DC voltage.

6. The high-efficiency power supply device as claimed in claim 5, wherein said backup voltage output unit has an efficiency about 70%.

7. The high-efficiency power supply device as claimed in claim 1, wherein said switch is a transistor selected from a group of NPN and PNP transistors.

8. The high-efficiency power supply device as claimed in claim 1, wherein said first terminal is the collector of the transistor, said second terminal is the base of the transistor, and said third terminal is the emitter of the transistor.

9. The high-efficiency power supply device as claimed in claim 1, wherein said switch is a power switch selected from a group of N-pass metal oxide semiconductor field effect transistor, N-pass junction metal oxide semiconductor field effect transistor, P-pass metal oxide semiconductor field effect transistor and P-pass junction metal oxide semiconductor field effect transistor.

10. The high-efficiency power supply device as claimed in claim 9, wherein said first terminal is the drain of the metal oxide field effect transistor, said second terminal is the gate of the metal oxide field effect transistor, and said third terminal is the source of the metal oxide field effect transistor.

11. The high-efficiency power supply device as claimed in claim 1, wherein the second terminal of said switch is selectively couplable to one of said second DC voltage output and a control signal of said main voltage output unit.
